(19) United States
(12) Patent Application Publication
(10) Pub. No.: US 2012/0185793 A1
(43) Pub. Date: Jul. 19, 2012

(54) TRIP PLANNING

(75) Inventor: Henri Binsztok, Paris (FR)

(73) Assignee: MLstate, Paris (FR)

(21) Appl. No.: 13/009,049

(22) Filed: Jan. 19, 2011

(51) Int. Cl. G06F 3/048

(52) U.S. Cl. 715/772

(57) ABSTRACT

A trip planning service allows users to easily edit and buy trips which consist of several items and elements. The trip planning service allows for editing a trip which respects a set of rules, such as rules that all nights have accommodations, scheduled visits are on intended days, etc. The trip planning service automatically updates elements to make them correct. In some examples, the trip planning service allows editing a trip in a single web page or interface screen through which the user interacts.

### BACKGROUND

This invention relates to trip planning, for instance, to a platform for trip or travel planning and sharing.

Online sales of flights, hotel rooms and other travel items have increased tremendously over past years. As of 2010, the online travel market is $146 billion in the United States alone, having surpassed the offline bookings for 3 years.

Generally, current online systems offer simple interfaces to perform database queries, for example, to identify and book available fights between two specified cities on a specified date. Some systems offer the ability to form a trip which consists of several flights, for example, with stopovers in a specified city between an origin and destination city.

Some systems have access to multiple travel-related databases and provide a user with access to related booking services, for instance, to make hotel reservations or rental car reservations to augment their flight plans.

The interfaces to existing systems are generally constrained by their relation to the existing database, and may require several different steps and/or interface pages to prepare an entire itinerary. Moreover, some of these interfaces allow for input of invalid combinations. For example, it is possible to enter a trip where a hotel room is missing for one night. Without mechanisms to check the trip consistency before booking it, potential mistakes may be discovered too late. Furthermore, it can be difficult to modify an itinerary, for example, extending a stay or changing the start date, without the user having to redo much of the interaction with the system.

Some vacation itinerary planning systems provide a scheduling aspect that allows a user to select activities, and to account for travel (e.g., driving) time between venues. For example, some systems provide a website portal for potential travelers to find localized information specific to a particular geographic area, and compile an itinerary using a database of tourist attractions, businesses, lodging establishments and restaurants within this area.

Some systems generate a list of places of interest geographically located near this calculated travel route. In an example, a user constructs an itinerary by dragging activities from a list. Activities can include restaurants, lodging, taxis etc. The user can share his complete plan with others involved in the current trip or those who plan subsequent related trips.

There is a need for a trip planning system that allows users to easily specify, check, modify and buy trips which consist of multiple interrelated items and elements.

### SUMMARY

In one aspect, in general, a trip planning service allows users to easily edit and buy trips which consist of several items and elements. The trip planning service allows for editing a trip which respects a set of rules, such as rules that all nights have accommodations, scheduled visits are on intended days, etc. The trip planning service automatically updates elements to make them correct. In some examples, the trip planning service allows editing a trip in a single web page or interface screen through which the user interacts.

In another aspect, in general, trips are represented as sets of linked items or elements. For instance, in some examples, travel legs are represented as directed links in a graph, and locations or stays, such stays in a city with accommodations, are treated as nodes in the graph, and a trip is represented as a path through a graph. The graph nature of the trip representation is manifested in the data structures used internally by the system, in the user interface representation, or both. The graph representations of some trips form cycles, with the origin and final destination being the same node.

In another aspect, in general, an online application models trips as graphs thereby allowing editing of the graph using a set of modification primitives and checking the consistency of the trip in real-time. In some examples, the graph nature enables or facilitates subsequence sharing of trips or portions of trips with other users.

In another aspect, in general, a computerized travel system maintains trip data representing trips for a plurality of users. Trips are represented in the trip data as corresponding paths through a set of linked data elements. A trip planning interface is provided to users. The trip planning interface provides a representation of a trip and accepts user input to specify a trip. The trip data is updated according to the accepted user input.

Aspects can include one or more of the following features.

The set of linked data elements form a graph representation including links representing travel elements and node representing location elements.

The data elements include travel data elements and location data elements.

A path representing a trip includes alternating travel data elements and location data elements.

The travel data elements include a data element representing at least one element from the group consisting of a flight travel element, a rail travel element, a bus travel element, an automobile travel element, a bicycle travel element, and a walking travel element.

The location data elements include a data element representing at least one element from the group consisting of an accommodation travel element, travel transfer point element, and an activity venue element.

Maintaining the trip data includes maintaining data for a partially-specified trip for a user.

The partially-specified trip for the user includes a partial specification of travel dates and/or times.

The partially-specified trip for the user includes a partial specification of selected accommodations at a location.

Updating the trip data includes verifying consistency of elements of the partially-specified trip for the user.

Updating the trip data includes further specifying the trip for the user based on user input from the user.

Providing the representation of the trip includes providing a representation of alternatives for elements of the trip.

Updating the trip data includes setting travel dates and/or times for a trip.

Updating the trip data includes changing a duration of a trip by changing a duration of at least one element of a trip.

Updating the trip data includes applying user preference data in specifying at least one element of a trip.

Providing a representation of a trip includes providing a graph-based graphical representation of a trip. In some examples, providing graph-based graphical representation includes providing said representation in conjunction with a corresponding map.

Accepting user input to specify a trip includes accepting a data representation of a partially specified trip.

The data representation of the partially specified trip originates from another entity (e.g., from a professional service) than the user that provided the user input. In some examples, the another entity includes an entity selected from the group consisting of a friend of the user that provided the user input, a member of a social network associated with said user, an entity providing a commercial offer related to the trip, a computerized search service, and a travel recommendation service.

Some examples include accepting a data representation of one or more trips. Updating the trip data according to the user input can then include using the accepted data representation of the trip. In some examples, the accepted data representation of the one or more trips comprises an extension of the system providing selections including at least one of a selection of accommodations, a selection of venues, and a selection of travel options. In some examples, the data representation of the one or more trips comprises graph-based representations of said trips, which may provide an effective way of building and distributing extensions to the system.

Providing the trip planning interface includes providing a group trip planning interface to a group of users enabling coordinated planning of individual trips.

Bookings of trip elements are caused by the system for the benefit of users.

Availability and total pricing of the trip is computed in real-time.

Graph nodes represent hotels, hostels, free options (staying with friends or family) and activities.

Graph edges represent flights, trains, cars, buses, hitch hiking, biking, hiking, or other commercial or free forms to transit.

The user can save, replay at a later date, or share his trips with friends.

The user can build several trips and/or several start dates making a set of options, and later chooses his trip between these options.

The user can buy the whole trip from the application, for example, with a single click. In some examples, the user interaction initiates interaction with booking and payment services to effect the purchase.

A cache is used to display immediate but approximate results and where the results are updated at once when current information is available.

Additional information or activities is displayed and some additional activities can be bought at once. For instance, such information can include weather, tourism, restaurants, clubs. In some examples, the data comes in all or in part from a structured database, which can be publicly accessible.

The application may suggest modifications of the trip to the user. For instance, the suggested modifications are based on cached results of other trips, a publicly editable database, or real-time information such as weather forecast.

The editing of a trip includes a method to stretch it to a given time window or duration.

In another aspect, in general, a travel system is configured to perform all the steps of any of the methods set forth above.

In another aspect, in general, a travel system includes: a data repository for trip data representing trips for a plurality of users, trips being represented in the trip data as a corresponding paths through a set of linked data elements; a user interface system for providing a trip planning interface to users, the trip planning interface providing a representation of a trip and accepting user input to specify a trip; and a trip planning system for updating the trip data according to the accepted user input. In some examples, the set of linked data elements form a graph representation including links representing travel elements and node representing location elements and the data elements include travel data elements and location data elements.

In another aspect, in general, software includes a tangible computer-readable medium embodies instructions for causing a data processing system to maintain trip data representing trips for a plurality of users, trips being represented in the trip data as a corresponding paths through a set of linked data elements; provide a trip planning interface to users, the trip planning interface providing a representation of a trip and accepting user input to specify a trip; and update the trip data according to the accepted user input.

Other features and advantages of the invention are apparent from the following description, and from the claims.

### DESCRIPTION OF DRAWINGS

FIG. 1 is a block diagram of a trip planning system.

FIG. 2 is a graph for an example trip.

FIG. 3 is a graph with a hierarchical model.

FIG. 4 illustrates a flow chart of a method for forming a trip.

### DESCRIPTION

### 1 Trip Planning System Overview

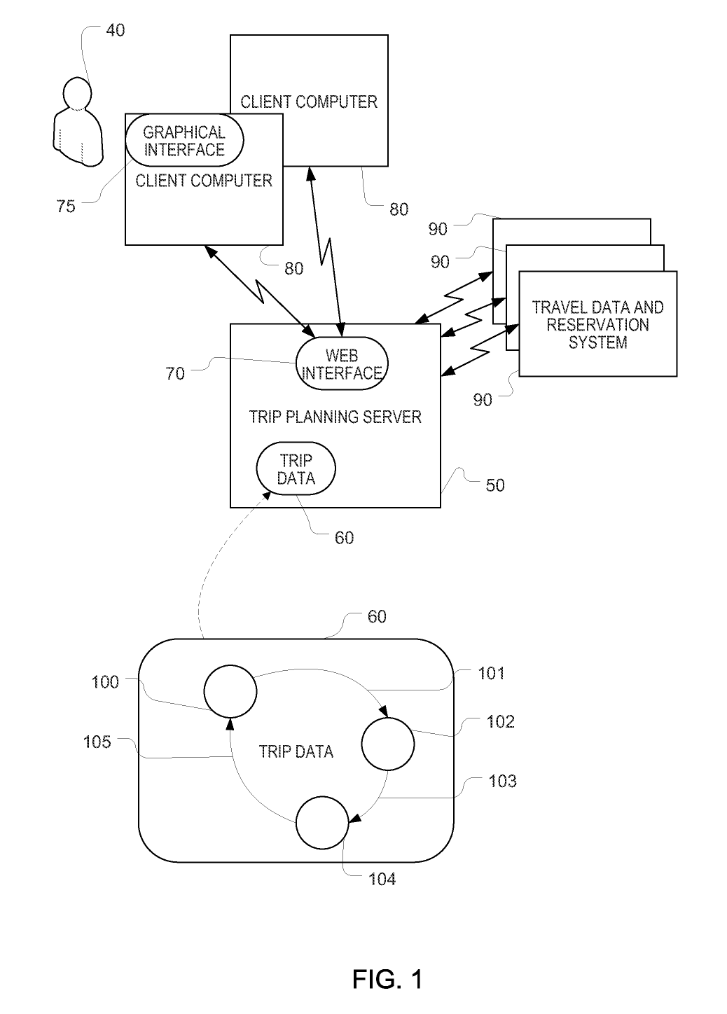

Referring to FIG. 1, a trip planning system includes a trip planning server 50, which provides trip planning services to a user 40. In some examples, the user 40 interacts with the system via a graphical user interface 75 at a client computer 80, or other personal and/or mobile device (e.g., cellphone, tablet computer, etc), which is coupled to a web interface 70, or other suitable interface, of the server via a network, for instance, the public Internet. In some examples, the user interface is controlled by a client “applet” that executes on the user's mobile device, and that communicates with a data interface at the server. The server may concurrently provide interfaces to many client computers 80. The trip planning server generally makes use of one or more travel data and reservation systems 90, for example, to determine available flights or hotel room and/or to affect bookings.

In the course of interacting with a user 40, the trip planning server 50 maintains trip data 60, which includes data representing a trip associated with the user 40. In a number of embodiments, trips are represented as sets of linked items or elements. For instance, in some examples, travel legs (i.e., physical travel) are represented as directed links in a graph, and locations, such as stays in a city with accommodations, are treated as nodes in the graph, and a trip is represented as a path through the graph. Note that in some examples of the system, a user may have multiple different trips or variants of a trip active in the system at one time, for example, in various stages of specification.

The graph representations of some trips (e.g., round trips) have paths that form cycles, with the origin and final destination being represented by the same node. For example, as illustrated in FIG. 1, an example path may include nodes 100, 102, 104 that are coupled by links 101, 103, 105, in which the nodes correspond the locations or stays, for example, with node 100 corresponding to a user's home location, and nodes 102 and 104 corresponding to two locations to be visited on his trip. Links 101, 103, 105 correspond to travel (e.g., flights, trains) between the locations associated with the source and destination nodes of the link.

The graph nature of the trip representation is manifested in the data structures used internally by the server, in the user interface representation, or both. Internal data structures manifesting the graph structure can use various programming or database approaches, for example without limitation, using separate software objects for each of the nodes and links and pointers (e.g., addresses, offsets, etc.) linking the objects, or database records for the nodes and links, with keys in the records being used to represent the graph structure. It should be understood that a variety of specific software approaches to representing the graph nature can be used, as long as a trip is represented as a sequence of linked elements (i.e., nodes and links) in the structure. Furthermore, the association of nodes with locations and links with legs is not essential. As one alternative, a bigraph (bipartite graph) may be used in which one group of nodes represents locations and another group of nodes represents legs, and edges link one node of one group with one node of another group.

Nodes and links may be associated with or extended by various data items, constraints, or other annotations, which are used by the trip planning system, for example, in specifying, editing, or optimizing a trip for a user. As an example, nodes and links may include time and pricing related data elements. For example, time data may represent the start and end times of a stay or travel leg and/or a duration of such a stay or leg. Pricing data may relate to a specific booking. Further annotation data associated with a node or link may include specific booking information (e.g., flight number, hotel name and room, etc.).

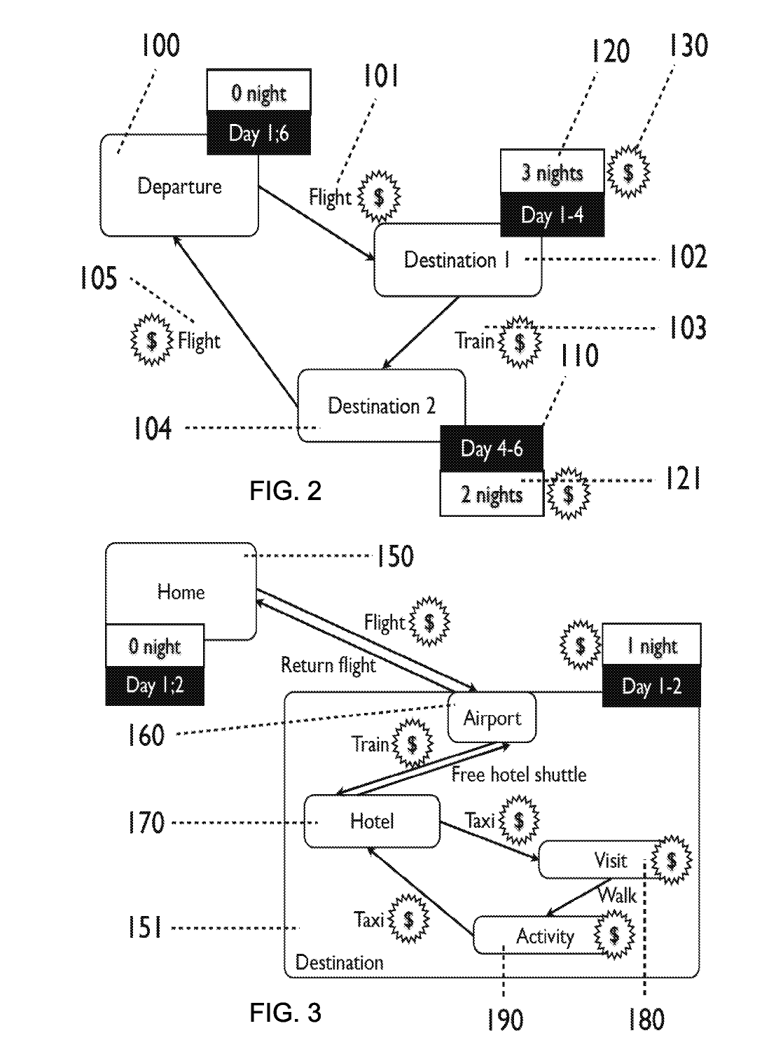

FIG. 2 is a schematic representation of graph of a sample trip, starting at “Day 1”, showing elements (either nodes or edges) that are linked to paid items. A departure node 100 represents the physical location of the trip departure. A flight represented by a link 101 moves the from Departure 100 to Destination 1 (102). The traveler will then take Train 103 to reach Destination 2 (104). As this is a round-trip, Flight 105 will take the traveler back to Departure 100. Nodes 100, 102, 104 are extended with time-related data. In particular, the days 110 where the traveler will be present at a node or the number of nights 120 spent at a node are computed by the system and used to annotate the nodes. Nodes and edges are also extended with financial data. In particular, items 101, 130, 103, 121, 105 are paid items and payment related data 130 is added to the items.

The granularity of time can vary in a trip representation. In the example above, the time unit is the day. But the trip description can be made more precise by the hour or the minute. Alternatively, the trip time unit can use less precise terms such as “Afternoon”, “Early morning”, “Evening”, “Between 4 pm and 6 pm”. In any case, the model structure enforces the notion of sequence, as we for instance expect node 104 to be reached after node 102.

The precision in location can also vary. In the example above, nodes 100, 102 and 104 can be cities (e.g. Paris, London, Manchester). In another example, nodes can be places within a given city, for example, a specific airport, train station, hotel, museum, etc..

Price related information 130 may include total amount, payment details (means, date, etc.) or any other useful data. Time related information 110, 120 may include lodging information (hotel name, address, etc.) or any other useful data. Such a total amount may take in account extra services, such as seat reservations, luggage, or any other fee. This allows making price comparison easier when services are unbundled from the base fare.

In some embodiments, the graph representations may be nested and provide hierarchical levels of granularity in time and/or location. A node for a stay, for example, for a multiday stay in a particular city may be representable as a nested subgraph that represents particular venues and travel within the city. FIG. 3 shows an example of a trip with one hierarchical level of granularity. The trip described is a return trip from Home 150 to Destination 151. Node 151 is itself a sub-trip, consisting of nodes 160, 170, 180 and 190.

It should be understood that during the process of forming a trip, for example, from its inception to booking of all the elements of the trip, the trip may at different times and for different portions have various levels of specificity, for instance, in data elements associated with the links and nodes, or with regard to nested detail in subgraphs for the trip. Note also that the process of specifying a trip does not necessary end with booking the trip. For example, a user may use an interface to the system to modify a trip that has already begun (e.g., if a user has just missed an airline connection, or their business plans have changed).

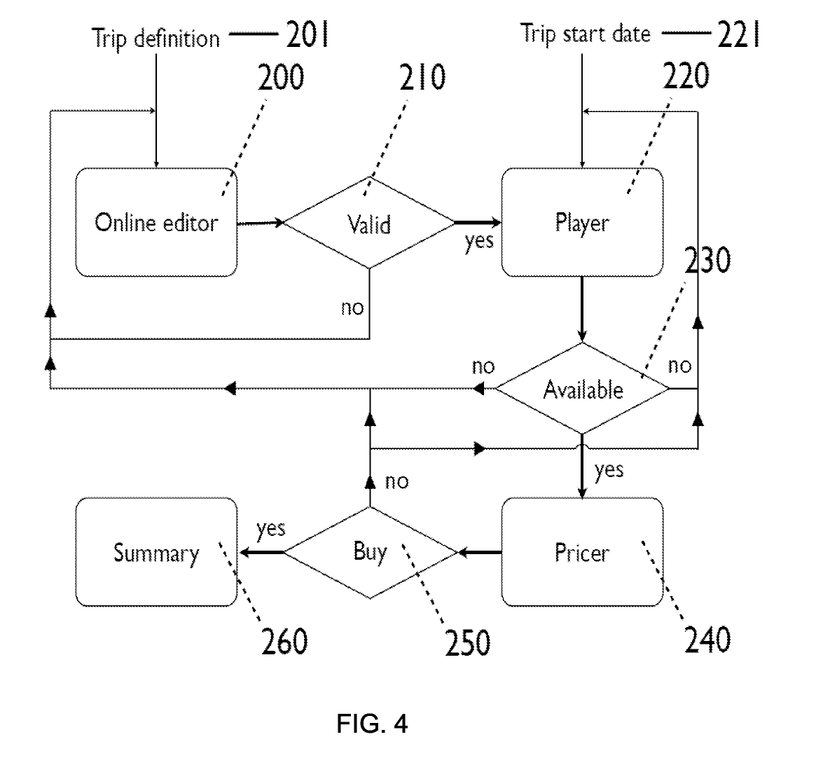

Referring to FIG. 4, an online editor 200, which comprises a software module executing within the trip planning server (or optionally executed wholly or in part on the user's client computer), accepts a trip definition 201 from the user. Note that the user may specify the trip with various degrees of specificity. For example, a trip from a home city, for instance, Boston, to a visited city, for instance, Paris, may correspond to a specification of two nodes (i.e., Boston and Paris), and two links (i.e., the outbound leg from Boston to Paris and the return leg from Paris to Boston), without necessarily specification of the travel dates, durations of stay, etc. associated with the trip. Note that FIG. 4 is only illustrative of one example implementation. There may be other states in the interaction, and aspects such as start and end dates may be integrated into the definition of a trip.

In some examples, the user may provide data and/or constraints for the nodes and links of the entered trip. For example, a desired time of day (e.g., afternoon, after 2:00 PM) may be specified for a leg, or a number of nights of stay or a day of the week may be specified for a location without specifying a particular date. For a flight, a specific carrier or set of acceptable carriers may be specified, without necessarily specifying a specific flight. For a node associated with a stay in a city, a specific hotel or set of hotels, or types of rooms, may be specified. Therefore, a trip definition may be considered as a template or a partial specification, and one function of the trip planning system is to form a fully specified and self-consistent validated trip based on such a trip definition.

Continuing to refer to FIG. 4, an online validator 210 checks in real-time if the trip is sound in the sense that data or constraints specified in the trip definition are self-consistent. For example, if specific dates are provided in the trip definition, they are checked to be consistent through the path representing the trip. If the trip is not valid, then the user must further edit his trip.

There are many trip properties that may be checked or enforced when building a trip. Various implementations may include all or some of the following properties, as well as other properties.
1) The trip must be complete: all transportations should exist, and all nights should be assigned (either lodging or night transport). This ensures, for example, that no hotel night is missing even in the case that a flight is an all-night flight that arrives the next morning after it departs.
2) The trip cannot have overlaps. This ensures that no night is booked twice in different places.
3) The transports and lodging must be consistent. For instance, it makes sense to stay in Paris then in Tokyo only if there is a transport from Paris to Tokyo between these two stays. This can be enforced by a graph representation of the trip.
4) The transports may have specificities that can be validated, such as the time necessary to a check-in for a flight.
5) When an inconsistency is detected, the interface should be updated automatically when the correction is obvious. Alternatively, an indication or an interactive tool can be shown to user.

Once a trip definition is declared to be valid, the trip can be further specified by the user using the system. One aspect of such a specification process is to establish specific dates through the trip, and in particular to set an actual trip start date 221. In one implementation used to establish specific dates for the elements of a trip, a player 220 is used to move through the trip from the start node. At each node or link, the player attempts to fully specify the element. For instance, for a travel link, the player determines whether a suitable flight matching the date and destination is available (e.g., flights are not fully booked). The player moves from element to element until the trip is fully specified. If an element cannot be specified, for example, because accommodations or flights are not available (block 230), the user must edit either the trip or its start date. If the player determines that all the accommodations and flights are available, a pricer 240 computes and displays the total price of the trip. The user can buy the trip (block 250), leading for instance, to a trip summary 260. If the user does not want to buy the trip, he or she can make further adjustments to the trip, for further interaction vial the online editor 200 or the player 220.

In some examples, the user is provided with choices as the player specifies each of the elements in a path. For example, a link associated with a flight may include a constraint the flight is direct, but the user may be offered choices of particular flight times or airlines.

In some examples, the online editor is combined with the player and as the user defines the trip, the editor continually applies rules to check the validity of the specification thus far, and to the extent possible the player aspect determines whether the elements are available. For example, start date and a return date may be specified through the editor, and even without having a full specification of all intermediate elements in a trip, the player aspect may be able to determine that not trip with that return date is available because all flights are already booked. Similarly, a trip may specify that the stay in a destination city must include a specified date range and fall within a specified duration, and the player aspect may identify available start and return dates based on available accommodations and flights.

Similarly, in some examples, the pricer may be combine with one or both of the editor and the player. For example, the pricer 240 may be displayed in an interface at the same time as the availability of the trip.

The trip summary generator 260 is optionally provided in the system, for example, to form a summary in various formats, for example, in a format that is easy to print or that is easy to integrate with third party applications like agendas.

The trip online creation may be done using a single adaptable online interface, in which all function calls result in updates of the online interface, without leaving the trip creation page.

### 2 Example Use Cases

The general approach described above enables examples of the trip planning system to perform functions based on the integrated graph-based representation of a trip. A number of these functions are described below.

Once a trip is specified, for example, based on a combination of the initial trip definition, and selections made in conjunction with the player aspect of the system, a user may wish to change the trip. For example, a trip may be specified with two nights of accommodations in Rome followed by a return flight. The room has been selected at a given price available on the specified price. The user may change the return date and add a third night to the stay in Rome. The player aspect then “replays” the changed part of the trip and determines whether the additional night is available at the hotel. If the hotel is not available, the user is informed. In some instances, an alternative selection of hotel for all three nights is proposed, or the player identifies that not available accommodations have been found meeting the new itinerary.

Another function may be referred to as “trip stretching” in which the trip planning system adapts a given trip (which may have specified dates for some or all of its elements) to fit a given new time window, defined either by a duration, or a start date and an end date. A stretcher aspect of the system generates a number of different variants of the trip, given the time window. For instance, if the trip should be one day longer than the initial one, the variants may include, without limitation, all trips where one of the stays is one day longer and trips with an extra one-day stay in an interesting place easily reachable from the initial trip. Some of the variants may be invalid, and are filtered out by the validity filter. Note that in stretching a trip, certain decisions need to be made, for example, a decision regarding in which city a stay is to be extended. Some decisions are made or suggested automatically by the system, for example, based on general rules and/or user-specific preferences or social context.

In some examples, the user has provided preference information to the trip planning system. Such preferences may include preferences regarding types of travel, preferred locations or hotel, price preferences, etc. In some examples, such preferences are used for automatically specifying or recommending elements the trip. For example, different user may select profiles such as “Cheapest,” “Comfort,” or “Luxury.” For instance, with the Cheapest profile, the least expensive hotel or airfare is selected automatically when adding or modifying nodes to the trip; when the user changes the start date, the whole trip is recomputed with the cheapest elements automatically. This way, the user quickly sees which start date leads to the least expensive trip (for instance with same destination and duration). As another example, with the Comfort profile, the least expensive direct flights (without stops) are selected, along with the least expensive 3-star minimum hotel. As yet another example, with the Luxury profile, 5-star hotels are selected and direct flights whenever possible, no matter the cost. Preference information may be used in trip stretching to identify those variants that match the user's preferences, or rank orders the variants according to quantitative characterizations of such preferences. In some examples, personal profiles with preferences are saved along with the user trips. Some elements may be communicated, provided the user agrees, to suppliers such as airlines or hotels, for instance to inform them about the status of the guest.

In some examples, the full specification of a trip does not proceed sequentially from the start of a trip. For example, after the user enters a partially specified trip, and optionally provides preferences, the system provides alternatives that match the specification, preferences and constraints of the trip. In some examples, the alternative trips are ranked by cost, or by other criteria (e.g., start date, duration, etc), and the user may select the criterion according to which the alternative trips are ranked. Note that the user's preferences may be general preferences such as generally preferring more expensive direct flights rather than less expensive indirect flights. Some preferences may relate to specific aspects of a trip, for example, a preference to travel on a specific date, but allowing with lower preference to travel on the day before or the date after the specified date. As the user makes selections with the trip, the set of alternatives is reduced and the presentation of the alternatives is updated. Removal of a selection similarly increases the set of alternative and the presentation is updated. In some examples, a relevance evaluator filters and rates the alternative trip variants, possibly taking advantage of user preferences, cached results of other trips, a structured base of trip hints, news from online services, or any other kind of information. Ultimately, only a single alternative remains or the user selects one of the presented alternatives as his selection. Note that constraints may be at various levels of detail. Activities, for instance, may have opening hours, and as an example, the system can then enforce that we should not schedule a visit to the Louvre on Tuesday, which is the weekly closing of the museum.

In another use scenario, a user starts with a trip that he has previously taken. For example, fully or partially specified trips may be stored for the user, or for a group of users such as users within a corporation. An example of a corporate trip might relate to a commonly taken trip by employees from a head office in one city to a branch office in another city. The trip may include preferences for airlines, car rental, and hotels, which may have preferred pricing for the corporations. In some examples, the storage of trips is accessible by identifiers (names), or other searches that relate to locations, keywords, or identifiers for the trip.

In some examples, portions of trips are available in a database or on distributed sites, and these portions of trips can be used as part of a larger trip, for example, as a subgraph in a larger graph. As an example, a hotel may provide a subgraph “trip” that links an airport to their hotel via a shuttle bus ride, an unspecified length of stay at the hotel, followed by a shuttle bus ride back to the airport. The user may access that trip part using the trip editor and insert it into a larger trip that has a stay in that city. Similarly, other short trips, such as day trips for site-seeing may be available from a library accessible to the user editing a trip. Therefore, complete trips may take in account door-to-door travel.

In some examples, the interface may provide “intelligent” buttons that suggest advice. For example, a trip that may not satisfy the constraints and preferences currently specified in the trip editor by the user may in fact be a better match to the user's needs. For example, the advice may be that if the start date can be changed by one day (i.e., and violate the specification or constraints of the trip), the price for the trip may be reduced by $1000 because the result would be an Saturday night stay which reduces airfare.

In some examples, trip specification is obtained from another user. For example, a trip that one user has taken may be posted on that user's social networking or community site (e.g., on Facebook, blog etc.). The posting may be a link to a trip repository that the user populated with the trip he took, possibly after editing to take out certain specifications that they do not want to make public. Another user may then access the fully or partially specified trip of that other user to use as a starting point to specifying their own trip. As an example, Sally may have taken a vacation travelling from Boston to Paris, and then to the Swiss Alps, and then flying back to Boston from Zurich. Another user Bob may copy Sally's trip for his own use, but change the origination city to New York where he lives, and the start date to the start of his work vacation and then extend the stay in Paris by a couple of days to visit relatives. Other aspects you as specific hotels at which Sally stayed, and the travel arrangements from Paris to Zurich may stay the same other than being shifted in time to accommodate the Bob's different start and end dates. As another example, a number of users may collaborate on a group trip, in which different users may have the ability to change shared aspects of the group trip. For example, Sally and Bob could be traveling together and may want to edit the same trip collaboratively. In some examples, the service provides real-time shared editing of the structured trip. For example, Sally could specifically allow Bob to alter her own trip. As another example, Bob might be a frequent traveler to Paris, and Sally may ask him to make some changes to make her trip better.

Shared trips, for example, on social networking sites, travel agent sites, etc. may be ranked (e.g., with a star system) so that other users can search for highly rated vacations. For example, some trips may make a “Top 10” of trips to a particular destination or region (e.g., Rome, Europe, etc.) or to a targeted audience (e.g., top 10 trips for young Americans) available for other to load and replay and/or edit to personalize to their own needs.

In some versions of the system, social networking features are integrated, or the system is linked to other social networking systems (e.g., Facebook). An aspect of some such version is that this integration or linking provides a way for users to build a community of travelers. For examples, users in such a community are thereby are able to share trips with friends, ask advices to people you can trust (friends or friends or friends who've been there), and edit trips simultaneously when several people are traveling together. Other related features may be integrated or associated with such systems. Such features can includes publishing trip related messages with hyperlinks on the “walls” of social networks such as Facebook, keeping a notion of friends, retrieved from social networks or specified directly in the platform, and display the list of friends (and their friends) that have been or are living in a city that a user is planning to visit or automatically suggesting to ask them for advice. In some versions of the system, privileges may be set up by users to permit other users to copy their trips. In some versions, a user may explicitly publish a trip and/or solicit feedback (e.g., votes, comments, etc.) from others. For instance, such feedback may be used to determine the “Top 10” lists of trips that are listed on the system.

In some versions of the system, a group buying feature is provided to users. One way that a provider of services may offer group based pricing is to require that at least a minimum number of travelers buy the offered service. Other ways include providing different pricing levels depending on the number of travelers that buy the service, for example, with a lowest pricing if the number exceeds a first threshold number, with other higher pricing levels if the number exceeds progressively lower threshold numbers. It should be understood that the services offered under such group pricing may include, for instance, flights, accommodations, or vehicle rental, and may also include combinations of such services. Such combinations may be offered with corresponding graph-based representations of the offered service, for instance, linking travel and accommodations, and/or at least partially constraining the service, for instance, according to particular or ranges of travel dates, selections of possible hotels, etc. In some examples, the graph is partially specified, for instance, by specifying flights to and from a city, but not specifying details at the city, such as accommodations, tours, etc. In some examples, such offers are published on a data network (e.g., over the Internet, or via electronic mailings) such that the user can select the offer and integrate the selected offer into a trip being planned by the user using the system.

In some versions of the system, user may receive group buying offers, and then be able to build trips, look for friends (or friends of their friends, or even members of a larger social network) to join them and benefit from lower costs. A variety of usage models that may be supported by versions of the system include one or more of the following:
1) Allow one person to build a trip and announce its intention to form a group;
2) Promote the trip to a circle of friends so that people could join them;
3) Each party may enter credit card information, so that the credit card is used if the group is formed;
4) Group trips may have a validity period, such that if the group is not complete at the end of the period, all engagements are cancelled;
5) A group may take the same flight (for instance from Paris to Rio de Janeiro) but people would split on arrival, each performing its own trip (with different hotels, places, etc.). The group would meet again for departure.

In some examples, if there is no electronic booking of flights for group, or hotel for groups, a travel agent/broker may negotiate the best price once the group is formed. For instance, upon booking, people would agree to pay a maximal price for the trip. If the negotiator can not find a price at or below this maximum, the trip will be cancelled.

In some versions of the system, structured representations of trips may be uploaded or downloaded in a documented format (e.g., according to a documented syntax, in XML format, etc.). For example, a third party (e.g., a travel agency) may build and provide access to database of information related to travel or trips. As another example, the system may allow individual or collaborative editing of trips that are stored in an external database.

In some versions of the system, such a documented uploading and downloading allows people to develop their own extensions and processes for the structured trips. For instance, one user could upload a “Culture in Europe” extension, that would automatically schedule visits to museum in the 10 biggest European cities when a user who is using this extension. Another extension “Romantic hotels in Paris” would suggest a short list of selected hotels for a stay in Paris; combined with a cheapest profile, the cheapest hotel in the short list, for the time of stay will be selected automatically. Several extensions can be combined and a user could for instance use both “Culture in Europe” and “Romantic hotels in Paris” at once. Some extensions can, for instance, provide dynamic packages, or pre-build trips made by professionals, for instance centered around a theme such as Golf, Scuba-diving, etc. In some examples, the extensions are represented in a data structure that embodies the graph structure. Such graph structure for extensions offers an effective way of building and distribution such extensions. In some examples, the system provides graph manipulation primitives that are used by extensions to modify a trip.

In some examples, similar trips may be grouped. For example, a travel planning system may retain trips that are bought by users, and frequent common elements may be provided to users through the editor interface, for example, through the presentation of the alternatives that match the user's constraints in a partially specified trip. In some examples, the graph nature of the trip representations is used to find related trips according to a path similarity metric.

In some examples, the user interface explicitly shows the graph nature of trips. For example, a trip may be shown as a travel path on a geographic map or in a schematic view, for example, with nodes labeled with locations, links with flight numbers, etc. The detail of the trip may be changed in such a graphical view when the user “zooms in”. In some examples, alternative trips are shown as alternative paths in the graphical interface, or as alternative labelings of links and nodes in the graphical representation.

Examples above are described in the context of a traveler interacting with the trip planning system. It should be understood that such a system could equally be used by a travel agent, who interacts with the user (e.g., over the telephone) and who assembles the trip for the user. In some examples, a trip planning system may provide access to both end travelers as well as agents, and provide different types of interfaces appropriate to different types of users (e.g., graphical versus tabular interfaces, etc.).

Implementations of the system may be implemented in software, which may include instructions stored on a computer-readable medium (e.g., magnetic or optical disk) that are executed on a computer processor. The software may execute at a server computer, at a client computer, or be distributed among several server computers and/or a client computer. In some implementations, the database that stores the graph representations of user trips is hosted in a storage system linked to the server, either directly or over a data network. In implementations that permit uploading or downloading of trip information, such transfers may use specifically defined application programming interfaces (APIs) and/of standardized data transfer protocols.

It is to be understood that the foregoing description is intended to illustrate and not to limit the scope of the invention, which is defined by the scope of the appended claims. Other embodiments are within the scope of the following claims.

What is claimed is:

1. A method comprising:
maintaining in a computerized travel system trip data representing trips for a plurality of users, trips being represented in the trip data as corresponding paths through a set of linked data elements;
providing a trip planning interface to users, the trip planning interface providing a representation of a trip and accepting user input to specify a trip; and
updating the trip data according to the accepted user input.

2. The method of claim 1 wherein the set of linked data elements form a graph representation including links representing travel elements and node representing location elements.

3. The method of claim 1 wherein the data elements include travel data elements and location data elements.

4. The method of claim 3 wherein a path representing a trip includes alternating travel data elements and location data elements.

5. The method of claim 3 wherein the travel data elements include a data element represent at least one element from the group consisting of a flight travel element, a rail travel element, a bus travel element, an automobile travel element, a bicycle travel element, and a walking travel element.

6. The method of claim 3 wherein the location data elements include a data element represent at least one element from the group consisting of an accommodation travel element, travel transfer point element, and an activity venue element.

7. The method of claim 1 wherein maintaining the trip data includes maintaining data for a partially-specified trip for a user.

8. The method of claim 7 wherein the partially-specified trip for the user includes a partial specification of travel dates and/or times.

9. The method of claim 7 wherein the partially-specified trip for the user includes a partial specification of selected accommodations at a location.

10. The method of claim 7 wherein updating the trip data includes verifying consistency of elements of the partially-specified trip for the user.

11. The method of claim 7 wherein updating the trip data includes further specifying the trip for the user based on user input from the user.

12. The method of claim 1 wherein providing the representation of the trip includes providing a representation of alternatives for elements of the trip.

13. The method of claim 1 wherein updating the trip data includes setting travel dates and/or times for a trip.

14. The method of claim 1 wherein updating the trip data includes changing a duration of a trip by changing a duration of at least one element of a trip.

15. The method of claim 1 wherein updating the trip data includes applying user preference data in specifying at least one element of a trip.

16. The method of claim 1 wherein providing a representation of a trip includes providing a graph-based graphical representation of a trip.

17. The method of claim 16 wherein providing graph-based graphical representation includes providing said representation in conjunction with a corresponding map.

18. The method of claim 1 wherein accepting user input to specify a trip includes accepting a data representation of a partially specified trip.

19. The method of claim 18 wherein the data representation of the partially specified trip originates from another entity than the user that provided the user input.

20. The method of claim 19 wherein the another entity includes an entity selected from the group consisting of a friend of the user that provided the user input, a member of a social network associated with said user, an entity providing a commercial offer related to the trip, a computerized search service, and a travel recommendation service.

21. The method of claim 1 further comprising accepting a data representation of one or more trips, and wherein updating the trip data according to the user input includes using the accepted data representation of the trip.

22. The method of claim 21 wherein the accepted data representation of the one or more trips comprises an extension of the system providing selections including at least one of a selection of accommodations, a selection of venues, and a selection of travel options.

23. The method of claim 21 wherein the data representation of the one or more trips comprises graph-based representations of said trips.

24. The method of claim 1 wherein providing the trip planning interface includes providing a group trip planning interface to a group of users enabling coordinated planning of individual trips.

25. The method of claim 1 further comprising causing bookings of trip elements for the benefit of users.

26. A travel system comprising:
a data repository for trip data representing trips for a plurality of users, trips being represented in the trip data as a corresponding paths through a set of linked data elements;
a user interface system for providing a trip planning interface to users, the trip planning interface providing a representation of a trip and accepting user input to specify a trip; and
a trip planning system for updating the trip data according to the accepted user input.

27. The system of claim 26 wherein the set of linked data elements form a graph representation including links representing travel elements and node representing location elements.

28. The system of claim 26 wherein the data elements include travel data elements and location data elements.

29. Software comprising a tangible computer-readable medium embodying instructions for causing a data processing system to
maintain trip data representing trips for a plurality of users, trips being represented in the trip data as a corresponding paths through a set of linked data elements;
provide a trip planning interface to users, the trip planning interface providing a representation of a trip and accepting user input to specify a trip; and
update the trip data according to the accepted user input.
